(19) United States
(12) Patent Application Publication
(10) Pub. No.: US 2007/0181250 A1
(43) Pub. Date: Aug. 9, 2007

(54) Endless belt and method for manufacturing same

(75) Inventor: Kazuaki Ikeda, Osaka (JP)

Correspondence Address: MCDERMOTT WILL & EMERY LLP, 600 13TH STREET, N.W., WASHINGTON, DC, 20005-3096, US

(73) Assignee: SUMITOMO ELECTRIC FINE POLYMER, INC, LTD.

(21) Appl. No.: 11/702,592

(22) Filed: Feb. 6, 2007

(30) Foreign Application Priority Data
Feb. 6, 2006 (JP) 2006-029021

(51) Int. Cl. B32B 37/00

(52) U.S. Cl. 156/294

(57) ABSTRACT

There are provided an endless belt having a structure containing at least three layers, a middle layer being disposed between the outermost layer and a bottom layer, and the middle layer being composed of a material having a thermal decomposition temperature lower than the deposition temperature of each of the outermost layer and the bottom layer, and provided a method for manufacturing the endless belt. There are provided an endless belt having high surface resistivity, an excellent toner releasing property, an excellent non-contaminated property, stable volume resistivity, excellent adhesion between a surface layer and an elastic layer, and the like without the occurrence of disadvantageous bleeding of a contaminant, and a method for manufacturing the endless belt.

### BACKGROUND OF THE INVENTION

1. Field of the Invention

The present invention relates to an endless belt and a method for manufacturing the endless belt. In particular, the present invention relates to an endless belt for an image-forming apparatus, such as a color copying machine or a color laser printer, using an electrophotographic method, the endless belt being used to transfer and fuse a toner image on a photosensitive drum to a sheet. The present invention also relates to a method for manufacturing the endless belt.

2. Description of the Background Art

Endless belts are used in various fields. For example, a method in which a toner image formed on a photosensitive drum is transferred and fused to a sheet or the like with an endless belt for an image-forming apparatus (hereinafter, also simply referred to as a “belt”, in particular, in Background Art) is employed as a method for transferring and fusing an image in a color-image-forming apparatus, such as a color copying machines and a color laser printer, which is becoming standard.

FIG. 9 is an explanatory schematic drawing of an intermediate transfer method as an example of this method. As shown in FIG. 9, a toner image is formed on a photosensitive drum 3 with toner 1 and development rollers 2. This system is a quadruple tandem transfer system. That is, four-color-toner cartridges, the development rollers, and the photosensitive drums are disposed. The toner image formed on the photosensitive drum 3 is transferred to a transfer belt 5 for an image-forming apparatus with primary transfer rollers 4, the photosensitive drum 3, and the transfer belt 5 for the image-forming apparatus. The formed color image is transferred to a transfer material (paper) 7 with a secondary transfer roller 6, the transfer belt 5 for the image-forming apparatus, and the transfer material (paper) 7 and is then fused with a fusing roller (not shown). In the case of a multi-layer transfer method, fundamental principles are identical to those described above.

A belt, such as a transfer belt, for an image-forming apparatus used in this method has high resistivity in the circumferential direction (surface resistivity) and lower resistivity in the thickness direction (volume resistivity) than the surface resistivity. The belt needs to have the following properties: for example, these resistivities are not changed in response to positions on the surface of the belt, usage environment, a voltage, and the like; a tensile modulus is high in the circumferential direction of the belt; the surface is smooth; a contact angle is large; toner is easily transferred to a transfer material (paper) (excellent toner releasing property); the photosensitive drum and toner are not chemically polluted with the belt (excellent non-contaminated property); and the belt is flame retardant.

A single-layer belt for an image-forming apparatus is difficult to satisfy these many properties. Thus, a multilayer belt for an image-forming apparatus is developed. For example, Japanese Unexamined Patent Application Publication No. 2002-287531 discloses a transfer belt for an image-forming apparatus, the transfer belt including a low-resistivity base layer composed of a thermoplastic elastomer and a high-resistivity surface layer composed of a thermoplastic elastomer, the base layer and the surface layer being formed by hot forming.

In recent years, a transfer belt for an image-forming apparatus has been desired, the transfer belt having elasticity in the thickness direction. To satisfy the property, a belt for an image-forming apparatus may include an elastic layer composed of an elastic body in addition to the base layer and the surface layer.

In the multilayer belt for an image-forming apparatus, a high tensile modulus in the circumferential direction is achieved by the base layer, and elasticity in the thickness direction is achieved by the elastic layer. On the other hand, stable volume resistivity is controlled by, for example, selection of materials for the base layer and the elastic layer. Furthermore, high surface resistivity, an excellent toner releasing property, and an excellent non-contaminated property are desirably achieved by the surface layer.

However, in the past, a belt sufficiently satisfying these properties for an image-forming apparatus, in particular, a transfer belt, is not produced.

The inventors found the following transfer belt for an image-forming apparatus as a transfer belt satisfying these requirements for an image-forming apparatus.

That is, the inventors found a transfer belt for an image-forming apparatus, the transfer belt including a base layer, an elastic layer disposed on the base layer and composed of an elastomer such as urethane, and a surface layer disposed on the elastic layer and composed of a fluorine content polymer.

The transfer belt for an image-forming apparatus includes the surface layer composed of the fluorine content polymer and thus can achieve high surface resistivity, excellent toner releasing property, and excellent non-contaminated property. The elastic layer composed of an elastomer such as urethane is disposed between the base layer and the surface layer; hence, the belt has sufficient flexibility in the thickness direction. Thereby, the transfer belt for an image-forming apparatus is obtained, the transfer belt being capable of transporting a material without crushing toner and achieving a higher quality image.

However, in the findings described above, the production of the fluorine content polymer constituting the surface layer and the elastomer, such as urethane, constituting the elastic layer is often difficult without modification because of a low thermal decomposition temperature of urethane.

It is conceivable that a material constituting the surface layer is applied to urethane or the like constituting the elastic layer by spray or dipping, followed by baking. However, the surface layer cannot be baked because the thermal decomposition temperature of urethane or the like of the elastic layer is lower than the baking temperature of the surface layer.

It is also conceivable that a surface layer in the form of a collapsible tube is fitted to a formed article formed of a base layer and an elastic layer. However, only a transfer belt having a small diameter (less than 100 mm) for an image-forming apparatus can be produced. Furthermore, it is difficult to produce a thin surface layer having a thickness of less than 30 μm.

In addition to these problems, a multilayer belt for an image-forming apparatus needs to be an endless form.

### Patent Document 1: Japanese Unexamined Patent Application Publication No. 2002-287531 (claim 1)

Accordingly, with respect to a belt such as a transfer belt for an image-forming apparatus, the belt including a base layer, an elastic layer disposed on the base layer, and a surface layer disposed on the elastic layer and composed of a fluorine content polymer, it has been desired to develop a method for manufacturing the belt for an image-forming apparatus without excessive efforts or excessive periods of time and a belt manufactured by the method for an image-forming apparatus, the belt having higher surface resistivity, an excellent toner releasing property, an excellent non-contaminated property, stable volume resistivity, and the like and ensuring satisfactory adhesion between the surface layer and the elastic layer, without the possibility of the disadvantageous bleeding of a contaminant.

Furthermore, in recent years, user demands for reliability and durability have been increasingly stringent. For example, the elastic layer is not melted or thermally deformed. Thus, it has been desired to develop a technique for more securely and efficiently bonding the elastic layer to the surface layer composed of a fluorine content polymer compared with the known art.

Moreover, it has been desired to develop a method for manufacturing a belt, but not limited to a belt for an image-forming apparatus, including at least three layers with satisfactory adhesion among the layers without excessive efforts or excessive periods of time and a belt manufactured by the method, the belt including an middle layer between the outermost layer and a bottom layer, the middle layer being composed of a material having a thermal decomposition temperature lower than the deposition temperature of each of the outermost layer and the bottom layer.

For example, in the image-forming apparatus, a fluoro resin, such as PTFE or PFA constituting the surface layer and a polyimide resin layer as the base layer need to be baked at about 380° C. A middle urethane layer has a thermal decomposition temperature of 150° C. to 180° C. Thus, it is impossible to form the layers in the order from the upper layer or the lower layer.

Furthermore, it has been desired to develop a method for bonding such layers and a belt produced by the method, in particular, a belt for an image-forming apparatus.

### SUMMARY OF THE INVENTION

The inventors have conducted intensive studies and found that the problems were overcome by optimizing materials of layers for an endless belt, in particular, a transfer endless belt for image-forming apparatus, forming a surface layer on the inner face of an external cylinder, forming an endless composite having an elastic layer on the outer face of a base layer separated from the surface layer, and pressing the endless composite to the inner face of the surface layer disposed on the inner face of the external cylinder under heating.

Furthermore, the inventors found that the problems were overcome by forming a surface layer and an elastic layer on the inner face of the external cylinder, separately forming an endless base layer, and pressing the endless composite to the inner face of the composite having the surface layer and the elastic layer disposed on the inner face of the external cylinder under heating.

Moreover, the inventors developed an optimal method for bonding layers by pressure heating to overcome the problems.

The present invention provides a method for manufacturing an endless belt having a structure containing at least three layers, a middle layer being disposed between the outermost layer and a bottom layer, and the middle layer being composed of a material having a thermal decomposition temperature lower than the deposition temperature of each of the outermost layer and the bottom layer, the method including:

a disposing step of fixing the outermost layer to the inner side of a rigid body and disposing the middle layer and the bottom layer in that order, the middle layer being opposite the bottom layer; and

an expansion pressurizing step of pressing the bottom layer from the inside of the bottom layer toward the outermost layer to form an endless belt having at least three layers.

In the present invention, an endless belt, e.g., an endless belt for an image-forming apparatus, having a structure containing at least three layers is manufactured, a middle layer being disposed between the outermost layer and a bottom layer, and the middle layer being composed of a material having a thermal decomposition temperature lower than the deposition temperature of each of the outermost layer and the bottom layer. The endless belt is manufactured by forming and fixing the outermost layer in the rigid body, disposing the middle layer and the bottom layer in that order, the middle layer being opposite the bottom layer, and pressing the bottom layer from the inside of the bottom layer toward the outermost layer to form an endless belt having at least three layers.

The middle layer composed of a material having a low thermal decomposition temperature is preferably disposed on the inner side of the outermost layer or the outer side of the innermost layer.

The phrase “material having a low thermal decomposition temperature” is not limited to a resin (a base resin of the middle layer) constituting the middle layer but includes a compounding agent and the like.

The present invention includes the case in which a plurality of middle layers are present, as long as even only one layer is composed of a material having a low thermal decomposition temperature.

In the expansion pressurizing step of pressing the bottom layer from the inside of the bottom layer toward the outermost layer, the bottom layer is expanded or stretched. Simultaneously, treatment such as evacuation or heating may be performed. When the outermost layer is composed of a material having poor adhesion, any other step, for example, a step of subjecting the inner face to treatment for improving adhesion, may be performed.

The present invention provides the method for manufacturing an endless belt described above, wherein
the endless belt has three layers,
the rigid body is an external cylinder,
the disposing step includes a surface-layer-forming substep and a composite-forming substep, the expansion pressurizing step includes a thermal adhesiveness substep, the surface-layer-forming substep includes forming and fixing a surface layer on the inner face of the external cylinder, the surface layer containing at least one of a polytetrafluoroethylene (PTFE) and a tetrafluoroethylene-perfluoroalkylvinylether (PFA) as a base material, the composite-forming substep includes forming a cylindrical composite having an elastic layer composed of an elastomer disposed on a base layer composed of at least one selected from the group consisting of polyimides (PIs), polyamideimides (PAIs), and polyvinylidene fluorides (PVDFs), and the thermal adhesiveness substep includes bonding the surface layer to the elastic layer of the composite by thermal adhesiveness.

In the present invention, the base material (i.e., base resin) of the surface layer of the three-layer endless belt is at least one of polytetrafluoroethylene (PTFE) and a tetrafluoroethylene-perfluoroalkylvinylether, i.e., one of them or a mixture of both, as a base (base material). Among fluorine content polymers, PTFE and PFA each have excellent surface resistivity, an excellent non-contaminated property, high (large) contact angle. Furthermore, an adherent such as toner can be cleanly separated.

The elastic layer is composed of an elastomer having elastic force. The base layer is composed of polyimide (PI), polyamideimide (PAI), polyvinylidene fluoride (PVDF), and the like, which are particularly satisfactory from the viewpoint that these materials each have a tensile modulus suitable for an endless belt for an image-forming apparatus and each have suitable adhesion to the elastic layer.

In the present invention, an endless belt having such excellent layers is manufactured by, as described above, forming and fixing the surface layer on the inner face of the external cylinder, separately forming the cylindrical composite having the base layer and the elastic layer, and bonding the outer face of the elastic layer of the cylindrical composite to the inner face of the surface layer by thermal adhesiveness.

In thermal adhesiveness, pressing is performed at 0.1 MPa or more and preferably 1 MPa or more under vacuum at a temperature of a melting point or more of the elastic layer.

A large endless belt (having a diameter of 100 mm or more), for example, an endless belt for an image-forming apparatus can be produced. Furthermore, it is possible to easily produce a thin surface layer having a thickness of less than 30 μm, in particular, about 1 μm. Moreover, a thick surface layer can also be produced.

The present invention provides a method for manufacturing an endless belt including a combination of layers having excellent specific properties. Note that the surface layer, the elastic layer, and the base layer correspond to the outermost layer, the middle layer, and the bottom layer, respectively.

In an endless belt, in particular, an endless belt for an apparatus using fine particles such as toner, for example, an endless belt for an image-forming apparatus, in order to improve toner releasing property, the surface roughness of the surface layer is preferably reduced. In the present invention, the requirement can be easily achieved by only subjecting the inner face of the external cylinder to mirror finish.

The present invention provides a method for manufacturing the endless belt, wherein the inner face of the external cylinder is mirror-finished.

Since the surface layer is formed on the inner face of the external cylinder, the composite needs to be formed in the external cylinder. The composite can be efficiently produced by the steps of forming the base layer on a cylindrical die, forming the elastic layer on the base layer, and separating the composite having the base layer and the elastic layer from the cylindrical die.

The present invention provides the method for manufacturing an endless belt described above, wherein the composite-forming substep includes a base-layer-forming subsubstep of forming the base layer on a cylindrical die, an elastic-layer-forming subsubstep of forming the elastic layer on the base layer, and a composite-forming subsubstep of separating the composite having the base layer and the elastic layer from the cylindrical die to form the cylindrical composite.

After the formation of the surface layer on the inner face of the external cylinder, the surface layer needs to be bonded to the elastic layer of the separately formed cylindrical composite having the base layer and the elastic layer.

In thermal adhesiveness, a method in which after insertion of the cylindrical composite into the inside of the external cylinder, the composite is heated and expanded to be bonded to the surface layer disposed on the inner face of the external cylinder is efficient and preferred.

Examples of the method include methods for using explosive force of explosives is used. A method for using the difference in coefficients of thermal expansion is preferred because heating means can be shared.

Specifically, there is an efficient method in which a core having a coefficient of thermal expansion higher than that of the cylindrical composite is inserted in the cylindrical composite, the core is inserted into the external cylinder, and the external cylinder and the core are heated to bond the surface layer to the composite by thermal adhesiveness.

The present invention provides the method for manufacturing an endless belt described above, wherein the thermal adhesiveness substep includes a first core-inserting subsubstep of inserting a core into the inner side of the cylindrical composite, the core having a larger coefficient of thermal expansion than that of the external cylinder, a second core-inserting subsubstep of inserting the core disposed in the composite into the external cylinder, and a pressure thermal adhesiveness subsubstep of heating the external cylinder and the core to bond the surface layer to the elastic layer of the composite by thermal adhesiveness under pressure.

The core is preferably composed of a material having a significantly larger coefficient of thermal expansion than that of metal external cylinder. For example, the core is preferably composed of nylon such as nylon 6 (trade name: MC nylon) having a coefficient of thermal expansion of about 8.0×10⁻⁵/° C. or a fluoro resin having a coefficient of thermal expansion of about 14×10⁻⁵/° C.

The present invention provides the method for manufacturing an endless belt described above, wherein the core is composed of nylon or a fluoro resin.

As another preferred method, there is a method in which the core is composed of a flexible elastic material such as a silicone rubber, and both ends (faces) of cylindrical core are pressed in the axial direction with a press or the like to expand the middle portion and to increase the diameter, thereby pressing the core toward the external cylinder.

The present invention provides the method for manufacturing an endless belt described above, wherein the thermal adhesiveness substep includes a first core-inserting subsubstep of inserting a core into the inner side of the cylindrical composite, the core being composed of an elastic material, a second core-inserting subsubstep of inserting the core disposed in the composite into the external cylinder, a core pressurizing subsubstep of pressing the elastic layer of the composite to the surface layer by pressing both ends of the core disposed in the external cylinder to expand the core and to increase the diameter of the middle portion of the core, and a pressure thermal adhesiveness subsubstep of heating the external cylinder and the core to bond the surface layer to the elastic layer of the composite by thermal adhesiveness under pressure while pressing both ends of the core.

As another preferred method, there is a method of using fluid pressure. In the method, bonding is performed under heating in a vacuum environment. Thus, no gas inclusion occurs, resulting in reliable bonding. Even when the core described above is used, thermal adhesiveness is preferably performed in a vacuum environment.

The present invention provides the method for manufacturing an endless belt described above, wherein the thermal adhesiveness substep includes a water-bag-inserting subsubstep of fitting the cylindrical composite to the perimeter of a hollow cylindrical water bag having closed ends and capable of changing the radius of the water bag by adjusting the pressure of fluid in the water bag, and inserting the water bag fitted with the composite into the inner side of the surface layer fixed on the inner face of the external cylinder, a vacuum subsubstep of evacuating a region surrounding the water bag after the completion of the water-bag-inserting subsubstep, a pressurizing subsubstep of pressing the periphery of the composite disposed on the perimeter of the water bag to the inner periphery of the surface layer by increasing the pressure of the fluid in the water bag to increase the diameter of the water bag after the completion of the water-bag-inserting subsubstep, a bonding subsubstep of heating the inside of a vacuum chamber to bond the periphery of the composite to the inner periphery of the surface layer after the completion of the vacuum subsubstep and the pressurizing subsubstep.

In the manufacturing method, the composite having the base layer and the elastic layer is fitted to the perimeter of a hollow cylindrical water bag having closed ends. The resulting water bag with the composite is inserted into the inner side of the surface layer fixed on the inner face of the external cylinder. A region surrounding the water bag is evacuated. The pressure of the fluid in the water bag is increased with a pump for regulating pressure to increase the diameter of the water bag provided with the composite, thereby pressing the periphery of the composite disposed on the perimeter of the water bag to the inner periphery of the surface layer. A vacuum chamber is heated to bond the surface layer to the composite. After the completion of bonding, the pressure is released to atmospheric pressure. After cooling, the pressure of the fluid in the water bag is reduced to reduce the diameter of the water bag. Then, the water bag is taken out from the resin endless belt in which the surface layer is tightly bonded to the composite.

Finally, the resin endless belt is separated from the inner face of the external cylinder.

The water bag may be composed of any material, as long as the diameter is controlled by the fluid therein.

The term “fluid” is not limited to water but includes a gas, silicone oil, or the like. In particular, when bonding is performed at 150° C. or higher, oil is preferred rather than water due to low vapor pressure of oil.

The pump for regulating pressure is not limited to a pump as long as the pressure in the water bag is controlled and regulated.

The reason bonding is performed in a vacuum is to prevent the occurrence of gas inclusions between bonding planes to form a void.

In the case of bonding of the inner face of the surface layer and the outer face of the composite, if the inner face of the surface layer is formed and fixed on the metal external cylinder, bonding is performed while the composite is pressed from the inner side thereof to the outer side in the radial direction, resulting in reliable bonding and satisfactory dimensional accuracy.

Bonding is performed in a vacuum, thus eliminating failures such as gas inclusions between bonding planes and ensuring satisfactory bonding and dimensional accuracy.

In the water bag that presses the surface layer from the inner side to the outer side in the radial direction during bonding, the diameter can be changed by controlling the fluid pressure in the water bag, thus facilitating insertion of the water bag into the inside of the surface layer before bonding and detachment of the water bag from the multilayer endless belt after bonding.

The water bag is preferably composed of a silicone rubber. Thus, the cylindrical portions pressed during bonding of the resin layers are flexible at temperatures up to about 200° C. to 250° C. Furthermore, the water bag has a satisfactory releasing property for a resin. Thus, after completion of bonding treatment, the water bag is easily detached from the resin endless belt having the surface layer bonded to the composite.

The present invention provides the method for manufacturing an endless belt described above, wherein the periphery of the water bag is composed of a silicone rubber.

The inventive above-described method for manufacturing an endless belt includes forming and fixing the surface layer on the inner face of the external cylinder, separately forming the cylindrical composite having the elastic layer disposed on the periphery of the base layer and fitting the cylindrical composite to the core or the water bag, expanding the core or the water bag under heating, preferably under heating and vacuum, and bonding the inner face of the surface layer to the periphery of the composite by thermal adhesiveness. However, the endless belt may be produced by forming the elastic layer on not the periphery but the inner face of the surface layer, fitting only the cylindrical elastic layer to the core or the water bag, expanding the core or the water bag under heating, preferably under heating and vacuum, bonding the inner face of the surface layer to the periphery of the composite by thermal adhesiveness, and further tightly bonding the surface layer to the elastic layer by thermal adhesiveness. The following description of the invention corresponds to the preferred embodiments.

The present invention provides the method for manufacturing an endless belt, the method including forming the surface layer on the inner face of the external cylinder and forming the elastic layer in the inner face of the surface layer, wherein the endless belt has three layers, the rigid body is the external cylinder, the disposing step includes a composite-forming substep and a base-layer-forming substep, the expansion pressurizing step includes a thermal adhesiveness substep, the composite-forming substep includes forming and fixing the surface layer on the inner face of the external cylinder, the surface layer containing at least one of a polytetrafluoroethylene (PTFE) and a tetrafluoroethylene-perfluoroalkylvinylether (PFA) as a base material, and forming the elastic layer composed of an elastomer on the inner face of the surface layer, the base-layer-forming substep includes forming a base layer on a cylindrical die, the base layer being composed of at least one selected from the group consisting of polyimides (PIs), polyamideimides (PAIs), and polyvinylidene fluorides (PVDFs), and the thermal adhesiveness substep includes separating the base layer from the cylindrical die, bonding the cylindrical base layer to the elastic layer of the composite by thermal adhesiveness, and further tightly bonding the surface layer to the elastic layer by thermal adhesion.

The present invention provides the method for manufacturing an endless belt described above, wherein the inner face of the external cylinder is mirror-finished.

The present invention provides the method for manufacturing an endless belt described above, wherein the thermal adhesiveness substep includes a first core-inserting subsubstep of inserting a core into the inner side of the cylindrical base layer, the core having a larger coefficient of thermal expansion than that of the external cylinder, a second core-inserting subsubstep of inserting the core disposed in the base layer into the external cylinder, and a pressure thermal adhesiveness subsubstep of heating the external cylinder and the core to bond the elastic layer of the composite to the base layer by thermal adhesiveness under pressure and further tightly bonding the surface layer to the elastic layer.

The present invention provides the method for manufacturing an endless belt described above, wherein the core is composed of nylon or a fluoro resin.

The present invention provides the method for manufacturing an endless belt described above, wherein thermal adhesiveness substep includes a first core-inserting subsubstep of inserting a core into the inner side of the cylindrical base layer, the core being composed of an elastic material, a second core-inserting subsubstep of inserting the core disposed in the base layer into the external cylinder, a core pressurizing subsubstep of pressing the base layer to the elastic layer by pressing both ends of the core disposed in the external cylinder to expand the core and to increase the diameter of the middle portion of the core, and a pressure thermal adhesiveness subsubstep of heating the external cylinder and the core to bond the base layer to the elastic layer of the composite by thermal adhesiveness under pressure and further tightly bonding the surface layer to the elastic layer while pressing both ends of the core.

The present invention provides the method for manufacturing an endless belt described above, wherein the thermal adhesiveness substep includes a water-bag-inserting subsubstep of fitting the base layer to the perimeter of a hollow cylindrical water bag having closed ends and capable of changing the radius of the water bag by adjusting the pressure of fluid in the water bag, and inserting the water bag fitted with the base layer into the inner side of the composite fixed on the inner face of the external cylinder, a vacuum subsubstep of evacuating a region surrounding the water bag after the completion of the water-bag-inserting subsubstep, a pressurizing subsubstep of pressing the periphery of the base layer disposed on the perimeter of the water bag to the inner periphery of the elastic layer by increasing the pressure of the fluid in the water bag to increase the diameter of the water bag after the completion of the water-bag-inserting subsubstep, and a bonding subsubstep of heating the inside of a vacuum chamber to bond the periphery of the base layer to the inner periphery of the elastic layer and further tightly bonding the surface layer to the elastic layer by thermal adhesiveness after the completion of the vacuum subsubstep and the pressurizing subsubstep.

The present invention provides the method for manufacturing an endless belt described above, wherein the periphery of the water bag is composed of a silicone rubber.

Examples of the elastomer constituting the elastic layer include urethane, acrylonitrile butadiene rubber, ethylene rubber, silicone rubber, and polyamides. Urethane is most preferably used.

An ionic conductive elastomer is preferably used in view of stability of volume resistivity.

The present invention provides the method for manufacturing an endless belt described above, wherein the elastomer is urethane.

The method for manufacturing an endless belt described above is especially suitable for a method for manufacturing an endless belt for an image-forming apparatus.

The present invention provides the method for manufacturing an endless belt described above, wherein the endless belt is an endless belt for an image-forming apparatus.

The endless belt produced by the method described above has larger surface resistivity, an excellent toner releasing property, an excellent non-contaminated property, further stable volume resistivity, and excellent adhesion between the surface layer and the elastic layer without the possibility of disadvantageous bleeding of a contaminant and thus can be used for a high quality image.

The present invention provides an endless belt produced by any of the manufacturing methods described above.

The endless belt is especially suitable for an endless belt for an image-forming apparatus.

The present invention provides an endless belt for an image-forming apparatus, the endless belt being produced by any of the manufacturing methods described above.

In the endless belt for an image-forming apparatus, the surface layer preferably has a thickness of 1 to 15 μm, the elastic layer preferably has a thickness of 50 to 300 μm, and the base layer preferably has a thickness of 30 to 100 μm.

The endless belt of the present invention, in particular, the endless belt for an image-forming apparatus, includes a transfer and fusing endless belt for an image-forming apparatus, wherein transferring and fusing being simultaneously performed with the transfer and fusing endless belt. In view of higher efficiency, the present invention is significantly preferably applied to such a transfer endless belt for an image-forming apparatus.

According to the present invention, it is possible to easily produce the endless belt having a structure containing at least three layers, the middle layer being disposed between the outermost layer and the bottom layer, and the middle layer being composed of a material having a thermal decomposition temperature lower than the deposition temperature of each of the outermost layer and the bottom layer.

The endless belt includes the surface layer composed of a fluoro resin, the elastic layer, and the base layer composed of an imide and thus has larger surface resistivity, an excellent toner releasing property, an excellent non-contaminated property, stable volume resistivity, and the like and ensures satisfactory adhesion between the surface layer and the elastic layer, without the possibility of the disadvantageous bleeding of a contaminant. It is possible to produce such an endless belt, in particular, an endless belt for an image-forming apparatus without excessive efforts, excessive periods of time, melting of the elastic layer, or thermal deformation of the elastic layer.

### BRIEF DESCRIPTION OF THE DRAWING

FIG. 1 is a conceptual diagram illustrating a state in which a composite is formed on the inner face of an external cylinder.

FIG. 2 is a conceptual diagram illustrating a state in which a composite is formed on the outer face of a drum-shaped die.

FIG. 3 is a conceptual diagram illustrating a state in which a core is fitted in a composite.

FIG. 4 is a conceptual diagram illustrating a state in which the core fitted in the composite is inserted in the inner side of a surface layer disposed on the inner face of the external cylinder.

FIG. 5 is a cross-sectional view of an endless belt for an image-forming apparatus according to an embodiment of the present invention.

FIG. 6 is a conceptual diagram illustrating a state in which a core fitted in a base layer is inserted in the inner side of a composite disposed on the inner face of the external cylinder.

FIG. 7 is a conceptual diagram illustrating the structure of an apparatus for bonding a surface layer to a composite using a water bag.

FIG. 8 is a conceptual diagram illustrating a state in which bonding is performed with the apparatus.

FIG. 9 is an explanatory schematic diagram illustrating an image transfer system with a transfer belt for an image-forming apparatus.

### DETAILED DESCRIPTION OF THE INVENTION

The present invention will be described below on the basis of the best mode for carrying out the invention. The present invention is not limited to embodiments described below. Various changes for the following embodiments may be made within the same or equivalent scope of the invention.

### First Embodiment

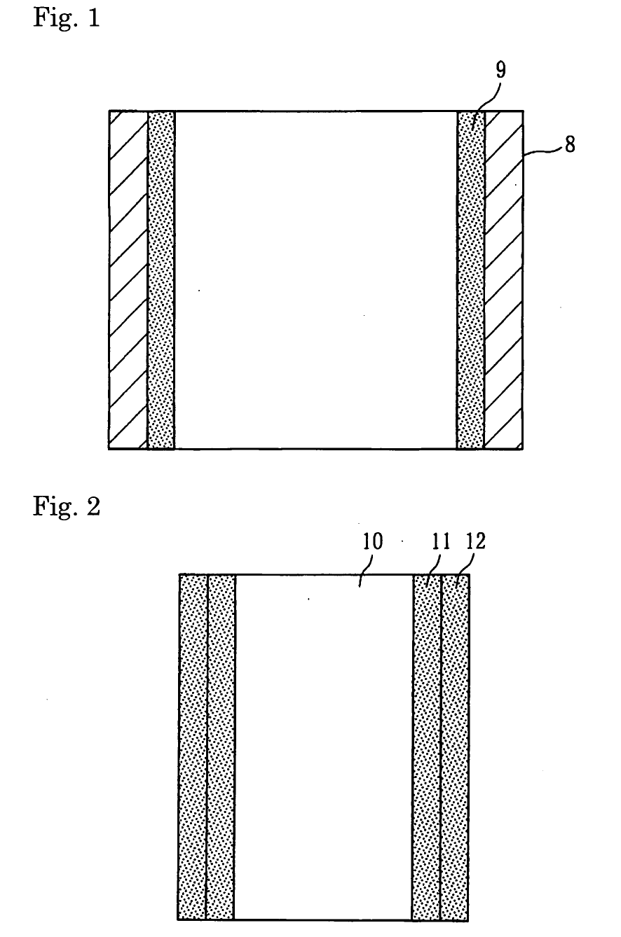

In this embodiment, a composite including an elastic layer disposed on the outer side of a base layer is inserted into the inner side of a surface layer, and a core is used for bonding of the surface layer and the elastic layer. As shown in FIG. 1, PTFE (melting point: 327° C., thermal decomposition temperature: 400° C.) was applied by dipping to the inner face of an external cylinder 8 having the mirror-finished inner face and composed of steel (stainless steel) having a coefficient of thermal expansion of 1.76×10⁻⁵/° C., and baked at 380° C. to form a surface layer 9.

As shown in FIG. 2, a surface of a drum-shaped die 10 was subjected to conducting treatment with carbon. A polyimide having adjusted volume resistivity was formed thereon and baked at 380° C. to form a base layer 11.

Aqueous urethane (melting point: 120° C., thermal decomposition temperature: 180° C.) to which ionic conductivity had been imparted was applied to the base layer 11 by dipping and dried to form an elastic layer 12.

Ionic conducting treatment was performed by dispersing an ionic conductor in aqueous urethane.

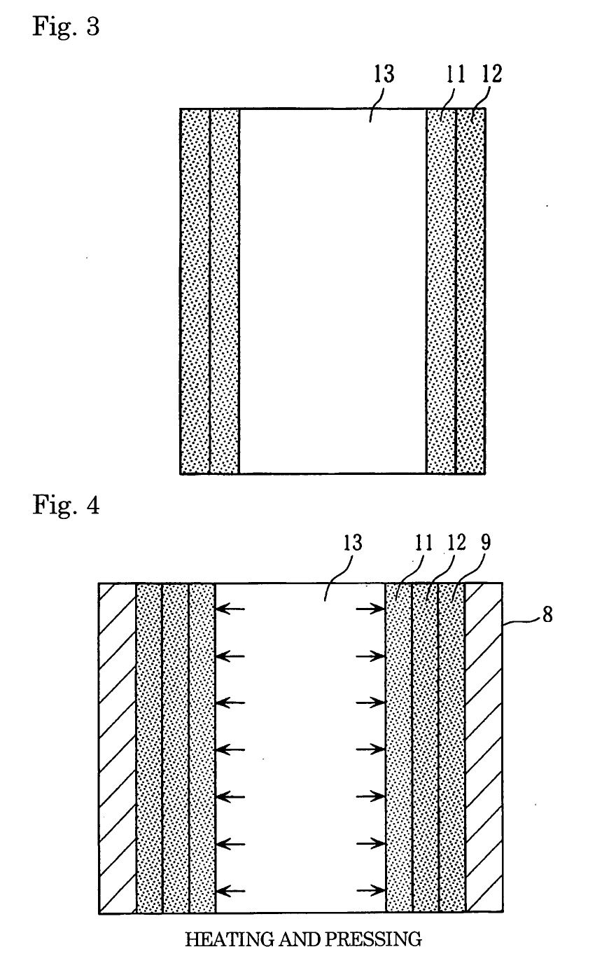

The composite of the base layer 11 and the elastic layer 12 disposed on the surface of the drum-shaped die was separated from the drum-shaped die 10. As shown in FIG. 3, the resulting cylindrical composite was fitted to the perimeter of a core 13 composed of nylon 6 (MC nylon, manufactured by Nippon Polypenco Limited) having a coefficient of thermal expansion of 8.0×10⁻⁵/° C.

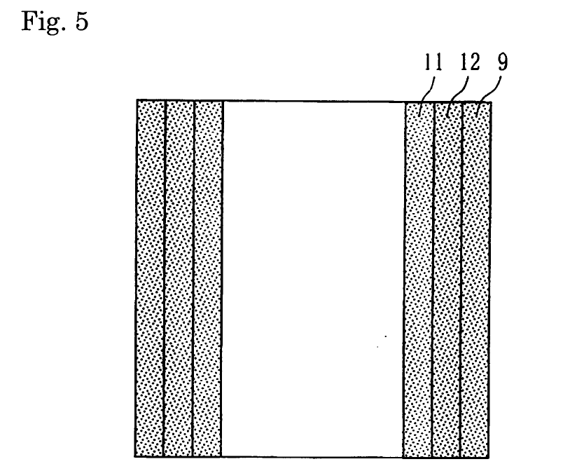

As shown in FIG. 4, the core 13 having the base layer 11 and the elastic layer 12 was inserted into the external cylinder 8 having the surface layer 9 disposed in the inner face thereof and heated to 150° C. under vacuum. The core 13 thermally expanded by heating pressed the inner face of the external cylinder 8 indicated by arrows shown in FIG. 4 because of the difference in coefficient of thermal expansion between the external cylinder 8 and the core 13. As a result, the elastic layer 12 of the composite layer having the base layer 11 and the elastic layer 12 was tightly bonded to the surface layer 9 by thermal adhesiveness to form a three-layer composite shown in FIG. 5.

The core 13 and the external cylinder 8 were cooled. The three-layer composite was separated from these components to produce an endless belt for an image-forming apparatus.

In the case, the mirror-finished external cylinder results in the mirror-finished outer face of the surface layer. Furthermore, the composite was easily separated from the external cylinder.

The resulting endless belt for an image-forming apparatus included the elastic layer (ionic conducting urethane) having a thickness of 200 μm and the surface layer (PTFE) having a thickness of 7 μm disposed on the base layer (polyimide) having a thickness of 65 μm. It was possible to produce the endless belt for an image-forming apparatus having excellent surface resistivity, an excellent toner releasing property, and an excellent non-contaminated property.

### Second Embodiment

The surface layer was tightly bonded to the elastic layer without bleeding.

In this embodiment, an elastic layer is formed on the inner face of a surface layer composed of a fluorine content polymer. A base layer is bonded to the inner face of the elastic layer by thermal adhesiveness. The surface layer is further tightly bonded to the elastic layer by thermal adhesiveness.

In the same way as in the first embodiment, PFA (350J manufactured by E, I, du Pont de Nemours & Company Inc. dispersion, particle size: 0.2 μm) (melting point: 295° C.) was applied dipping to the inner face of an external cylinder 8 having the mirror-finished inner face and composed of steel having a coefficient of thermal expansion of 1.76×10⁻⁵/° C., and baked at 380° C. to form a surface layer.

The inner face of the surface layer was subjected to adhesion-improving treatment, such as plasma treatment or radical treatment. Aqueous urethane (melting point: 120° C., thermal decomposition temperature: 180° C.) to which ionic conductivity had been imparted was applied by dipping and dried to form an elastic layer.

Ionic conducting treatment was performed by dispersing an ionic conductor in aqueous urethane.

The base layer was formed on a surface of a drum-shaped die in the same method as in the first embodiment. Then, the base layer was separated from the drum-shaped die. The resulting cylindrical base layer was fitted to the perimeter of a core composed of a flexible silicone rubber.

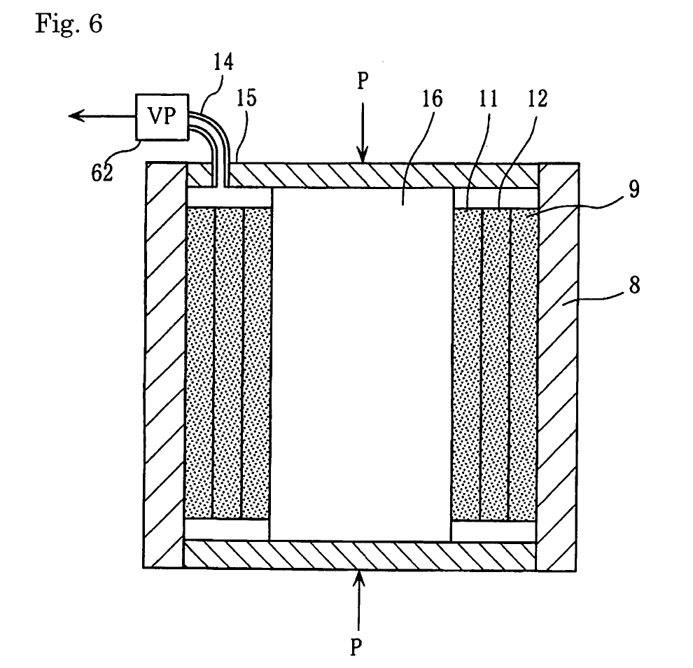

As shown in FIG. 6, the core 16 having the base layer 11 was inserted into an external cylinder 8 having the surface layer 9 and the elastic layer 12. Ends of the gate-insulating layer 16 were pressed with disk-shaped spacers 15 composed of nylon 6. Then, heating was performed at 140° C. for 20 minutes.

The middle portion of the core 16 would be expanded, i.e., the diameter of the core 16 would be increased, by pressure indicated by P shown in FIG. 6. However, the base layer 11 is bonded to the elastic layer 12 by thermal adhesiveness under heat and pressure because the metal external cylinder 8 is not substantially deformed. The surface layer 9 is further tightly bonded to the elastic layer 12 by thermal adhesiveness. Thereby, a three-layer composite similar to that shown in FIG. 5 was produced.

The core 16 is slightly longer than the width of each of the surface layer 9, the base layer 11, and elastic layer 12 in such manner that only pressing force in the direction from the core 16 to the external cylinder 8 during pressing is applied.

A spacer 15 is provided with a line 14 and a vacuum pump 62 for evacuation. Thus, evacuation can be performed before pressing.

Next, the whole was cooled. Press was released to return pressure to atmospheric pressure, and the core 16 was taken out. A three-layer composite was separated from the external cylinder 8 to produce an endless belt for an image-forming apparatus.

The resulting endless belt for an image-forming apparatus included the elastic layer (ionic conducting urethane) having a thickness of 200 μm and the surface layer (PFA) having a thickness of 5 μm disposed on the base layer (polyimide) having a thickness of 60 μm. It was possible to produce the endless belt for an image-forming apparatus having excellent surface resistivity, an excellent toner releasing property, and an excellent non-contaminated property.

Furthermore, the volume resistivity of a transfer endless belt for an image-forming apparatus was stably controlled with the elastic layer 12.

Moreover, the elastic layer was tightly bonded to the base layer and the surface layer without bleeding.

### Third Embodiment

In this embodiment, a fluorine content polymer constituting a surface layer is composed of 70 parts of PFA and 30 parts of PTFE. A composite is produced as in the first embodiment. A water bag is used for bonding of the surface layer and the composite.

First, an apparatus will be described.

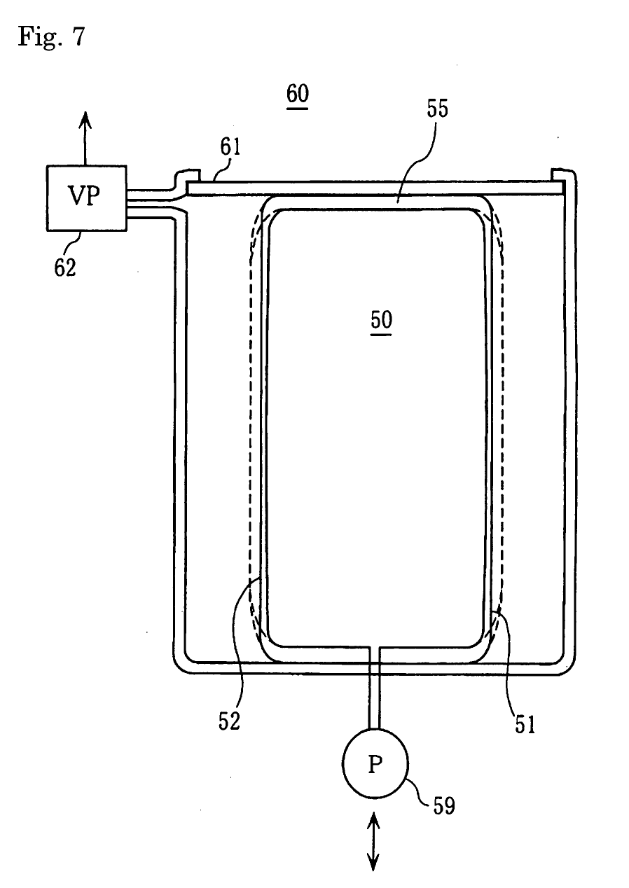

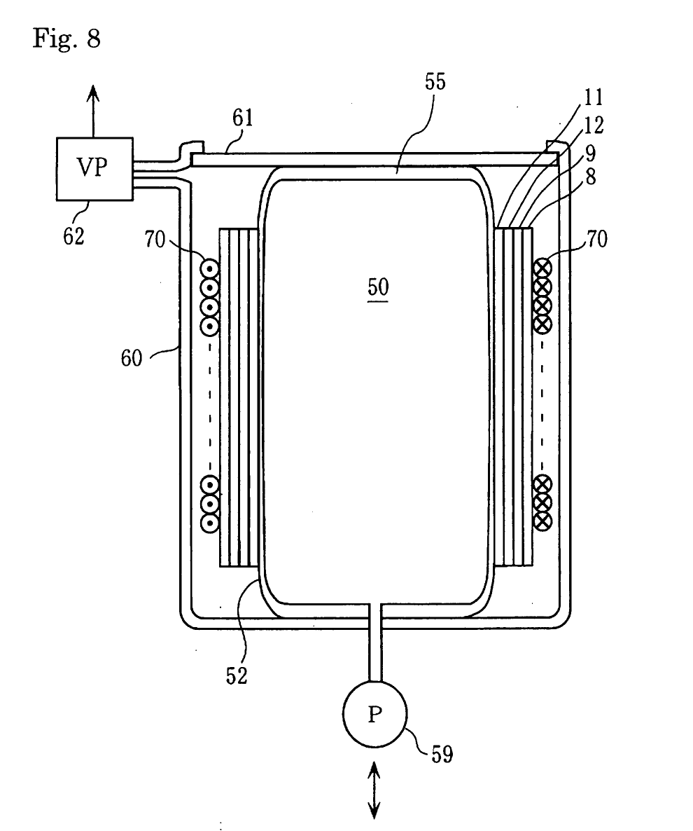

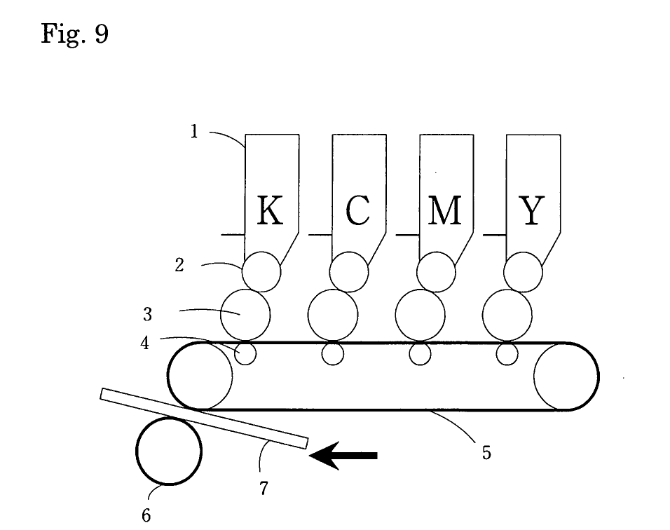

Bonding of the surface layer and the composite will be described with reference to FIGS. 7 and 8. FIG. 7 shows a whole water bag 50, a middle portion 51 indicated by a solid line of the water bag, a middle portion 52 indicated by a dotted line when the diameter is increased, end plates (panels) 55 disposed on upper and lower ends of the middle portion, a pump 59, a vacuum chamber 60, a cap 61 of the vacuum chamber, and a vacuum pump 62. FIG. 7 shows a detachable electric heater 70.

The water bag 50 is a type of container for a liquid as a whole. The middle portion 51 is composed of a silicone rubber. Thus, as shown in FIG. 7, the middle portion 51 can be expanded by increasing the pressure of contained fluid with the pump 59. The thickness of the middle portion 51 is 10 mm in order to have self-support. This does not affect expansivity at all.

The thickness of the middle portion of the silicone rubber is slightly small in such a manner that the water bag 50 is expanded from the middle portion of the adherend.

The vacuum chamber 60 is a type of container. The vacuum chamber 60 is configured in such a manner that the water bag 50 having a semifinished resin belt wound around the perimeter thereof is detachable to the inside of the vacuum chamber 60 under the vacuum chamber 60 is connected to the pump 59. Thus, the cap 61 that can open and close is disposed on the upper side of the vacuum chamber 60. The vacuum pump 62 is connected to the inside of the vacuum chamber 60.

In fact, these components have more complex structures. For example, the middle portion 51 of the water bag 50 is connected to the end plates 55 with a complex seal mechanism. However, the complex structures are remotely related to the gist of the present invention and thus are not shown.

A state in which bonding is performed will be described below with reference to FIG. 8.

FIG. 8 illustrates a state in which the water bag 50 having the semifinished composite composed of the base layer 11 and the elastic layer 12 is disposed in the external cylinder 8 having the surface layer 9 fixed on the inner face thereof, the external cylinder 8 is disposed in the vacuum chamber 60, and the pressure of the contained fluid is increased in a vacuum environment.

As a result, the semifinished resin belt formed of the three resin layers is pressed to the inner face of the external cylinder 8 with the middle portion 52 of the water bag 50 expanded by internal pressure.

At this point, the external cylinder 8 is made of stainless steel and thus is not deformed at all. The middle portions 51 and 52 are formed of films each composed of a silicone rubber; hence, when the fluid pressure in the water bag 50 is increased to 100 atm, the whole of the water bag 50 uniformly presses the resin layers to the inner face of the external cylinder 8, regardless of the presence of the end plates 55 at both ends.

In this point, air in the vacuum chamber 60 is evacuated with the vacuum pump 62 to achieve a vacuum in the vacuum chamber 60.

The inside of the vacuum chamber 60 is maintained at 120° C. while holding this state to heat the three-layer endless resin for 20 minutes. The middle portion 52 of the water bag 50 expanded during heating was uniformly pressed to the inner face of the external cylinder 8 to produce a three-layer resin belt having the surface layer 9 tightly bonded to the composite having the base layer 11 and the elastic layer 12.

Then, the pressure in the vacuum chamber 60 was released to atmospheric pressure, and the temperature was reduced to room temperature. The fluid pressure in the water bag 50 was reduced. The external cylinder 8 having the three resin layers on the inner face was taken out from the vacuum chamber 60. The three-layer resin belt was separated from the external cylinder 8 to obtain an endless belt for an image-forming apparatus.

The resulting endless belt for an image-forming apparatus included a middle layer (urethane) having a thickness of 200 μm and the surface layer (PFA and PTFE) having a thickness of 5 μm disposed on the base layer (polyimide) having a thickness of 60 μm. It was possible to produce the endless belt for an image-forming apparatus having excellent surface resistivity, an excellent toner releasing property, and an excellent non-contaminated property.

Furthermore, the adhesion between the middle layer and the surface layer was satisfactory.

### Fourth Embodiment

In this embodiment, a surface layer is the same as in the third embodiment. An elastic layer is formed on the inner face of the surface layer in the same method as in the second embodiment. A cylindrical base layer is formed in the same method as in the second embodiment. The elastic layer is bonded to the base layer by thermal adhesiveness with a water bag in the same way as in the third embodiment. The surface layer is further tightly bonded to the elastic layer by thermal adhesiveness.

Also in this embodiment, a significantly excellent endless belt could be produced.

A method for manufacturing the endless belt and the technical content such as materials are substantially the same as in embodiments described above. Thus, detailed description is omitted.

What is claimed is:

1. A method for manufacturing an endless belt having a structure containing at least three layers, a middle layer being disposed between the outermost layer and a bottom layer, and the middle layer being composed of a material having a thermal decomposition temperature lower than the deposition temperature of each of the outermost layer and the bottom layer, the method comprising:
a disposing step of fixing the outermost layer to the inner side of a rigid body and disposing the middle layer and the bottom layer in that order, the middle layer being opposite the bottom layer; and
an expansion pressurizing step of pressing the bottom layer from the inside of the bottom layer toward the outermost layer to form an endless belt having at least three layers.

2. The method for manufacturing an endless belt according to claim 1, wherein
the endless belt has three layers,
the rigid body is an external cylinder,
the disposing step includes a surface-layer-forming substep and a composite-forming substep,
the expansion pressurizing step includes a thermal adhesiveness substep,
the surface-layer-forming substep includes forming and fixing a surface layer on the inner face of the external cylinder, the surface layer containing at least one of a polytetrafluoroethylene (PTFE) and a tetrafluoroethylene-perfluoroalkylvinylether (PFA) as a base material,
the composite-forming substep includes forming a cylindrical composite having an elastic layer composed of an elastomer disposed on a base layer composed of at least one selected from the group consisting of polyimides (PIs), polyamideimides (PAIs), and polyvinylidene fluorides (PVDFs), and
the thermal adhesiveness substep includes bonding the surface layer to the elastic layer of the composite by thermal adhesiveness.

3. The method for manufacturing an endless belt according to claim 2, wherein the inner face of the external cylinder is mirror-finished.

4. The method for manufacturing an endless belt according to claim 2 or 3, wherein the composite-forming substep includes
a base-layer-forming subsubstep of forming the base layer on a cylindrical die,
an elastic-layer-forming subsubstep of forming the elastic layer on the base layer, and
a composite-forming subsubstep of separating the composite having the base layer and the elastic layer from the cylindrical die to form the cylindrical composite.

5. The method for manufacturing an endless belt according to claim 2, wherein the thermal adhesiveness substep includes
a first core-inserting subsubstep of inserting a core into the inner side of the cylindrical composite, the core having a larger coefficient of thermal expansion than that of the external cylinder,
a second core-inserting subsubstep of inserting the core disposed in the composite into the external cylinder, and
a pressure thermal adhesiveness subsubstep of heating the external cylinder and the core to bond the surface layer to the elastic layer of the composite by thermal adhesiveness under pressure.

6. The method for manufacturing an endless belt according to claim 5, wherein the core is composed of nylon or a fluoro resin.

7. The method for manufacturing an endless belt according to claim 2, wherein the thermal adhesiveness substep includes
a first core-inserting subsubstep of inserting a core into the inner side of the cylindrical composite, the core being composed of an elastic material,
a second core-inserting subsubstep of inserting the core disposed in the composite into the external cylinder,
a core pressurizing subsubstep of pressing the elastic layer of the composite to the surface layer by pressing both ends of the core disposed in the external cylinder to expand the core and to increase the diameter of the middle portion of the core, and
a pressure thermal adhesiveness subsubstep of heating the external cylinder and the core to bond the surface layer to the elastic layer of the composite by thermal adhesiveness under pressure while pressing both ends of the core.

8. The method for manufacturing an endless belt according to claim 2, wherein the thermal adhesiveness substep includes
a water-bag-inserting subsubstep of fitting the cylindrical composite to the perimeter of a hollow cylindrical water bag having closed ends and capable of changing the radius of the water bag by adjusting the pressure of fluid in the water bag, and inserting the water bag fitted with the composite into the inner side of the surface layer fixed on the inner face of the external cylinder,
a vacuum subsubstep of evacuating a region surrounding the water bag after the completion of the water-bag-inserting subsubstep,
a pressurizing subsubstep of pressing the periphery of the composite disposed on the perimeter of the water bag to the inner periphery of the surface layer by increasing the pressure of the fluid in the water bag to increase the diameter of the water bag after the completion of the water-bag-inserting subsubstep, and
a bonding subsubstep of heating the inside of a vacuum chamber to bond the periphery of the composite to the inner periphery of the surface layer after the completion of the vacuum subsubstep and the pressurizing subsubstep.

9. The method for manufacturing an endless belt according to claim 8, wherein the periphery of the water bag is composed of a silicone rubber.

10. The method for manufacturing an endless belt according to claim 1, wherein
the endless belt has three layers,
the rigid body is an external cylinder,
the disposing step includes a composite-forming substep and a base-layer-forming substep,
the expansion pressurizing step includes a thermal adhesiveness substep,
the composite-forming substep includes forming and fixing a surface layer on the inner face of the external cylinder, the surface layer containing at least one of a polytetrafluoroethylene (PTFE) and a tetrafluoroethylene-perfluoroalkylvinylether (PFA) as a base material, and forming an elastic layer composed of an elastomer on the inner face of the surface layer,
the base-layer-forming substep includes forming a base layer on a cylindrical die, the base layer being composed of at least one selected from the group consisting of polyimides (PIs), polyamideimides (PAIs), and polyvinylidene fluorides (PVDFs), and
the thermal adhesiveness substep includes separating the base layer from the cylindrical die, bonding the cylindrical base layer to the elastic layer of the composite by thermal adhesiveness, and further tightly bonding the surface layer to the elastic layer by thermal adhesion.

11. The method for manufacturing an endless belt according to claim 10, wherein the inner face of the external cylinder is mirror-finished.

12. The method for manufacturing an endless belt according to claim 10, wherein the thermal adhesiveness substep includes
a first core-inserting subsubstep of inserting a core into the inner side of the cylindrical base layer, the core having a larger coefficient of thermal expansion than that of the external cylinder,
a second core-inserting subsubstep of inserting the core disposed in the base layer into the external cylinder, and
a pressure thermal adhesiveness subsubstep of heating the external cylinder and the core to bond the elastic layer of the composite to the base layer by thermal adhesiveness under pressure and further tightly bonding the surface layer to the elastic layer.

13. The method for manufacturing an endless belt according to claim 12, wherein the core is composed of nylon or a fluoro resin.

14. The method for manufacturing an endless belt according to claim 10, wherein thermal adhesiveness substep includes
a first core-inserting subsubstep of inserting a core into the inner side of the cylindrical base layer, the core being composed of an elastic material,
a second core-inserting subsubstep of inserting the core disposed in the base layer into the external cylinder,
a core pressurizing subsubstep of pressing the base layer to the elastic layer by pressing both ends of the core disposed in the external cylinder to expand the core and to increase the diameter of the middle portion of the core, and
a pressure thermal adhesiveness subsubstep of heating the external cylinder and the core to bond the base layer to the elastic layer of the composite by thermal adhesiveness under pressure and further tightly bonding the surface layer to the elastic layer while pressing both ends of the core.

15. The method for manufacturing an endless belt according to claim 10, wherein the thermal adhesiveness substep includes
a water-bag-inserting subsubstep of fitting the base layer to the perimeter of a hollow cylindrical water bag having closed ends and capable of changing the radius of the water bag by adjusting the pressure of fluid in the water bag, and inserting the water bag fitted with the base layer into the inner side of the composite fixed on the inner face of the external cylinder,
a vacuum subsubstep of evacuating a region surrounding the water bag after the completion of the water-bag-inserting subsubstep,
a pressurizing subsubstep of pressing the periphery of the base layer disposed on the perimeter of the water bag to the inner periphery of the elastic layer by increasing the pressure of the fluid in the water bag to increase the diameter of the water bag after the completion of the water-bag-inserting subsubstep, and
a bonding subsubstep of heating the inside of a vacuum chamber to bond the periphery of the base layer to the inner periphery of the elastic layer and further tightly bonding the surface layer to the elastic layer by thermal adhesiveness after the completion of the vacuum subsubstep and the pressurizing subsubstep.

16. The method for manufacturing an endless belt according to claim 15, wherein the periphery of the water bag is composed of a silicone rubber.

17. The method for manufacturing an endless belt according to claim 2, wherein the elastomer is urethane.

18. The method for manufacturing an endless belt according to claim 1, wherein the endless belt is an endless belt for an image-forming apparatus.

19. An endless belt produced by the method according to claim 1.

20. An endless belt for an image-forming apparatus, the endless belt being produced by the method according to claim 1.
